(19) United States
(12) Patent Application Publication
(10) Pub. No.: US 2026/0257349 A1
(43) Pub. Date: Sep. 3, 2026

(54) Robot Manipulation Skill Learning Through Diffusion Models and Sub-Task Segmentation

(71) Applicant: FANUC CORPORATION, Yamanashi (JP)

(72) Inventors: Yu Zhao, Santa Clara, CA (US); Hsien-Chung Lin, Fremont, CA (US); Tetsuaki Kato, Union City, CA (US)

(21) Appl. No.: 19/068,364

(22) Filed: Mar. 3, 2025

(51) Int. Cl. B25J 9/16; G06V 10/774; G06V 10/82

(52) U.S. Cl. CPC B25J 9/163; B25J 9/1697; G06V 10/82; G06V 10/774

(57) ABSTRACT

A method and system for robot skill learning applicable to challenging manipulation tasks. A diffusion model neural network is used to control the robot. The diffusion model is configured with sub-task segmentation to overcome cumulative drifting error over a long-horizon operation. Fixed and robot-arm-mounted cameras provide global and local visual input to the diffusion model through a vision encoder, along with robot gripper pose data. The diffusion model controller is first pre-trained in an offline mode using human demonstration data. A step-wise de-noising network included in the diffusion model is trained by adding noise to the demonstration trajectory record and training the denoise network to remove the added noise in steps. The diffusion model controller is then deployed in inference mode with the trained de-noising network, where a short-horizon robot trajectory is predicted at each step and then a next short-horizon trajectory is computed in a feedback loop.

### BACKGROUND

### Field

The present disclosure relates generally to a method for robot skill learning and, more particularly, to a method for robot skill learning applicable to challenging manipulation tasks, where a diffusion model is used with sub-task segmentation to overcome cumulative drifting error, global and local visual input is provided to the diffusion model, and the model is first pre-trained using human demonstration data and then deployed in inference mode.

### Discussion of the Related Art

The use of industrial robots to repeatedly perform a wide range of manufacturing and assembly operations is well known. However, some types of manipulation operations, such as cable routing and installation in harness fixtures, are still problematic for robots to perform. These types of operation are often performed manually because robots have difficulty detecting and correcting the complex dynamics that may arise in such tasks. That is, because of challenges in state estimation, and unintended remote consequences of cable manipulation, both open-loop and feedback control systems struggle to provide robot control to effectively complete the task.

Various techniques have been employed to attempt to improve robot performance in complex manipulation tasks such as those involving flexible workpieces. One such technique, model-based programming, requires complicated models for planning and control, and complex state estimation in order to operate. This technique has therefore found only limited use.

Imitation learning simplifies the programming by using demonstration data for training, where learned feedback control operates the robot at every step. However, imitation learning is subject to cumulative learning error, which results in drifting away from optimal performance during operation.

Reinforcement learning is another neural network-based approach, which uses automatic trial and error to learn feedback control parameters for the robot. This technique requires a very long training time, and is not suitable for long-horizon operations. Design of the reward function for reinforcement learning is also troublesome.

Diffusion model-based imitation learning is another technique which has some advantages for complex tasks as described above. However, cumulative error is a problem for long-horizon operations when using traditional diffusion model imitation learning.

In view of the circumstances described above, improved methods are needed for robotic skill learning in complex manipulation applications particularly involving flexible elements.

### SUMMARY

The following disclosure describes a method and system for robot skill learning applicable to challenging manipulation tasks. A diffusion model neural network is used to control the robot. The diffusion model is configured with sub-task segmentation to overcome cumulative drifting error over a long-horizon operation. Fixed and robot-arm-mounted cameras provide global and local visual input to the diffusion model through a vision encoder, along with robot gripper pose data. The diffusion model controller is first pre-trained in an offline mode using human demonstration data. A step-wise de-noising network included in the diffusion model is trained by adding noise to the demonstration trajectory record and training the denoise network to remove the added noise in steps. The diffusion model controller is then deployed in inference mode with the trained de-noising network, where a short-horizon robot trajectory is predicted at each step and then a next short-horizon trajectory is computed in a feedback loop.

Additional features of the present disclosure will become apparent from the following description and appended claims, taken in conjunction with the accompanying drawings.

### BRIEF DESCRIPTION OF THE DRAWINGS

FIG. 1 is an illustration of a cable routing application, depicting an example of a challenging robotic manipulation task which can benefit from the techniques of the present disclosure;

FIG. 2 includes illustrations of some of the types of challenges presented by the cable routing application depicted in FIG. 1;

FIG. 3 is an illustration of the cumulative error experienced by a traditional diffusion model-based technique, along with an illustration depicting how sub-task segmentation is used to overcome the effects of cumulative error, according to embodiments of the present disclosure;

FIG. 4 is a block diagram illustration of a system configured for a robotic operation using a controller with a diffusion model trained to compute robot motions for a difficult manipulation task, according to embodiments of the present disclosure;

FIG. 5 is a flowchart diagram of a method for training a diffusion model control system to correlate future states with current operating condition input, according to embodiments of the present disclosure;

FIG. 6 is a block diagram illustration of a technique for training a diffusion model control system to correlate future states with current operating conditions input using demonstration data, and a corresponding technique for using the trained diffusion model system for robot control based on gripper states and image data input, according to embodiments of the present disclosure; and

FIG. 7 is a flowchart diagram of a method for operating a diffusion model control system in inference mode to control robot future states based on current operating condition input, according to embodiments of the present disclosure.

### DETAILED DESCRIPTION OF THE EMBODIMENTS

The following discussion of the embodiments of the disclosure directed to a method for robot manipulation skill learning using diffusion models is merely exemplary in nature, and is in no way intended to limit the disclosed techniques or their applications or uses.

The use of industrial robots for a wide variety of manufacturing, assembly and workpiece manipulation operations is well known. The present disclosure is directed to overcoming the challenges encountered in many robotic manipulation operations involving flexible workpiece members.

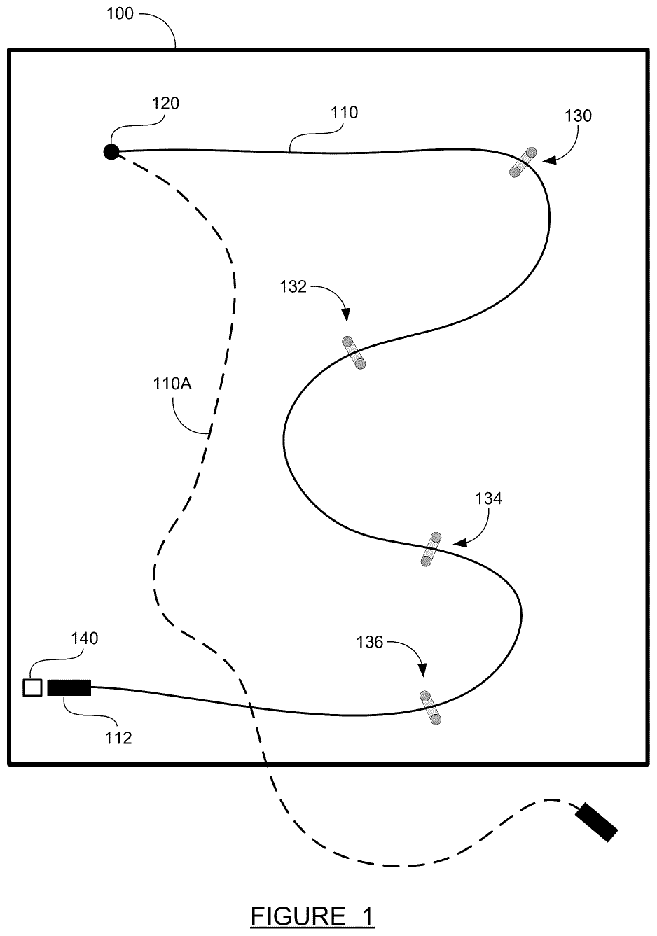

FIG. 1 is an illustration of a cable routing application, depicting an example of a challenging robotic manipulation task which can benefit from the techniques of the present disclosure. An enclosure 100 is a device into which a cable 110 needs to be routed and installed. The enclosure 100 could be any machine or system, or a part thereof—such as a computer housing, an under-hood area of an automobile, an electrical or control cabinet of a machine, etc. The enclosure 100 is not even necessarily “enclosed”—it simply represents a work area in which the cable 110 is to be routed.

The cable 110 is initially lying loosely in a somewhat random shape indicated by 110A (the dashed line). The cable 110 is fixed at one end at a point 120—such as where the cable 110 enters the enclosure 100. The task for a robot (not shown) is to route the cable 110 through a series of guide fixtures 130-136 and to a terminal location where a plug 112 on the cable 110 can be plugged into a receptacle 140. The guide fixtures 130-136 may be any type of device designed to constrain the position of a portion of the cable. In one example, the guide fixtures 130-136 may be thought of as “goal posts”, where the cable must be laid down between posts of each guide fixture which are perpendicular to the page of FIG. 1. The guide fixtures 130-136 may include features for capturing the cable 110 once it is in position—where the cable 110 may be grasped tightly by the guide fixture, or the cable 110 may be allowed to slide axially but not move substantially in transverse directions.

The task for the robot is to route the cable 110 through the guide fixture 130, then through the guide fixture 132, the guide fixture 134 and the guide fixture 136 in sequence, and then position the plug 112 adjacent to the receptacle 140. The robot may include a special type of gripper which facilitates loosely grasping the cable 110 to constrain its lateral motions while permitting axial cable motion, and the gripper may also include a feature designed for “clicking” the cable 110 into each of the guide fixtures.

The exact details of the cable, end fitting, etc., are not important to the present discussion. The important point is that routing a slack cable along a path with several fixed waypoints and involving several curves and turns is a difficult task for a robot to perform. Some of the reasons for this are discussed below.

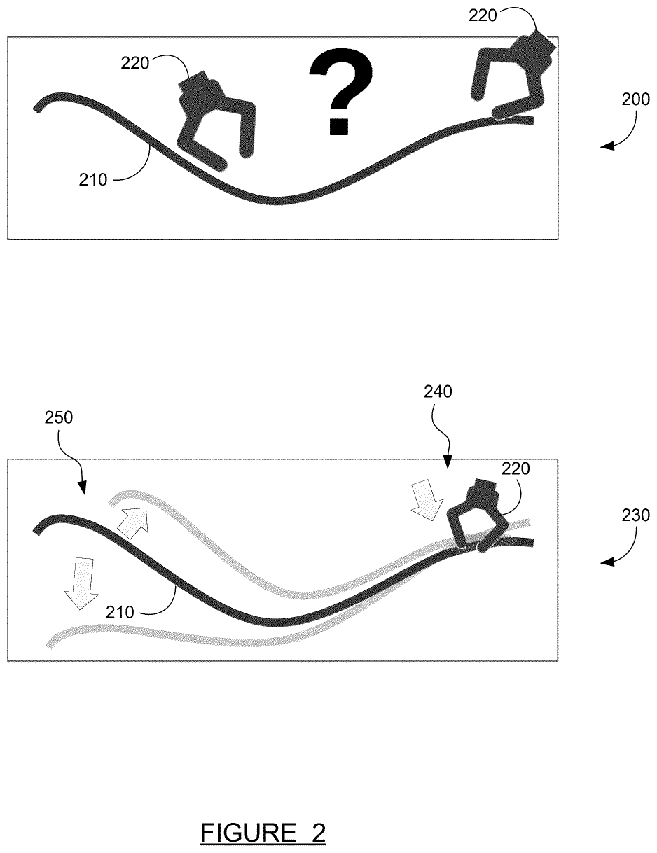

FIG. 2 includes illustrations of some of the types of challenges presented by the cable routing application depicted in FIG. 1. An illustration 200 depicts a first challenge faced by the robot—where and how to grasp the cable. A cable 210 is loose and slack, having an initial shape before grasping by the robot. It is likely that the cable 210 has a three-dimensional shape—including the two-dimensional curvature apparent in FIG. 2 along with curvature in the third dimension (into and out of the page). The robot is fitted with a gripper 220 (depicted in two different locations merely to represent the uncertainty regarding where to grasp the cable 210). Simply ascertaining exactly where the cable 210 is located is one challenge—as the cable 210 is slender and may be difficult to locate precisely with images, for example. Even more challenging is determining where along its length to grasp the cable 210—that is, the best grasping location based on the next required cable routing movement. This is because the grasping location affects the subsequent motions required to route the cable along the required path as illustrated in FIG. 1, and the effects are difficult to predict.

An illustration 230 depicts another challenge faced by the robot—the fact that movement of one portion of the cable 210 causes unintended and often unforeseeable movement of other portions of the cable 210. In the illustration 230, the gripper 220 has grasped the cable 210 as indicated at 240. As the robot moves the gripper 220 and the corresponding portion of the cable 210, other parts of the cable 210 (which are not tightly constrained, even if they are routed through a guide fixture) move in unintended and often unpredictable ways. This is illustrated conceptually at 250 where the cable 210 moves from an initial position (the center position of the three) one way or the other based on the movement of the gripper 220.

In addition to the challenges depicted in the two illustrations of FIG. 2, there are other difficulties to content with in robotic manipulation applications such as cable routing. Referring again to FIG. 1, it can be understood that the robot cannot simply move the gripped portion of the cable 110 to the guide fixture 130, then to the guide fixture 132, etc., in a point-to-point fashion. Rather, the robot must sort of drag a portion of the cable 110 into one of the guide fixtures, then gently curve and route the cable 110 in the direction of the next guide fixture, and so forth. Furthermore, even if an ideal gripper trajectory can be determined for one individual instance of the cable 110, that same trajectory might not work for the next instance of the cable 110, due to differences in pre-set shapes of the cables.

The illustrations of FIGS. 1-2 are merely exemplary, and many other types of manipulation tasks exist which are difficult to perform robotically—particularly in cases where the workpiece is flexible and differences exist from one workpiece to the next.

Systems exist for controlling robotic manipulation of workpieces in uncertain environments, as discussed earlier. However, all of these existing control methods exhibit problems—such as long training time, lack of robust performance, and cumulative drifting error for long-horizon operations.

The present disclosure describes methods for robot manipulation skill learning using diffusion model-based imitation learning techniques which overcome the drawbacks of existing methods of programming or teaching a robot to perform certain manipulation tasks. The disclosed method uses a diffusion model trained through human demonstration, and the manipulation task is divided using sub-task segmentation to control cumulative error and task variance. Global and local camera images are provided as input, along with robot gripper pose data, and the diffusion model is used to predict short-horizon trajectories which will lead to successful task completion. All of this is discussed in detail below.

A diffusion model is a type of neural network used in machine learning applications such as image analysis. The goal of diffusion models is to learn a diffusion process for a given dataset, such that the process can generate new elements that are distributed similarly as the original dataset. Diffusion models may be used for computer vision tasks, including image denoising, image generation, and video generation. These typically involve training a neural network to sequentially denoise images blurred with Gaussian noise. The model is trained to reverse the process of adding noise to an image. After training to convergence, it can be used for image (or dataset) generation by starting with an image (or dataset) composed of random noise, and applying the network iteratively to denoise the image.

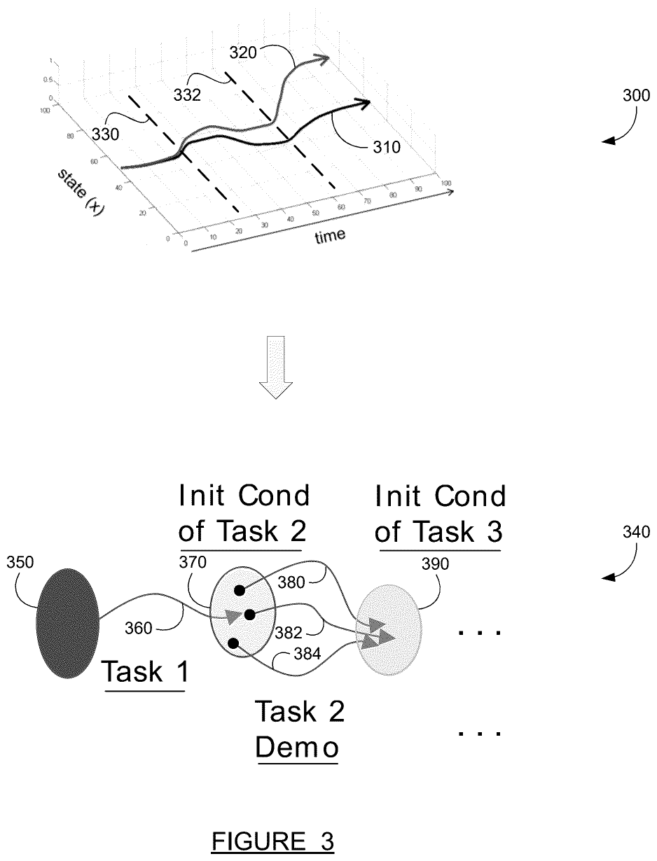

One problem with existing diffusion model-based techniques is that they accumulate error over a long trajectory. FIG. 3 is an illustration of the cumulative error experienced by a traditional diffusion model-based technique, along with an illustration depicting how sub-task segmentation is used to overcome the effects of cumulative error, according to embodiments of the present disclosure.

A graph 300 plots values of a robot state (such as the X position of the tool center point) versus time for a nominal diffusion model-based prediction (trajectory 310) and for one actual trajectory including task variation (trajectory 320). The graph 300 depicts the cumulative error experienced by a traditional diffusion model-based technique over the duration of a long-horizon task such as the one depicted in FIG. 1. Conceptually, if the single long-horizon task could be divided into sub-tasks—such as at times indicated by dashed lines 330 and 332—and each sub-task trained individually using demonstration data specific to that sub-task, then the error can be corrected at each sub-task transition rather than accumulating over the duration of the entire task. Specifically, in the case of cable routing as depicted in FIG. 1, the overall task can be segmented into a first sub-task of cable grasping, a second sub-task of cable routing, and a third sub-task of “clicking” the cable into each of the guide fixtures.

An illustration 340 depicts how sub-task segmentation is used to overcome the effects of cumulative error described above, according to embodiments of the present disclosure. In the illustration 340, the complete task is divided into three sub-tasks, those being the grasping, routing and clicking portions of the overall operation as described above.

An ellipse 350 represents a robot state (e.g., X position of gripper, as in the graph 300) at the beginning of the operation. A trajectory 360 is the trajectory for the particular robot state over the first sub-task (e.g., grasping). An ellipse 370 represents the robot state at the beginning of the second sub-task (e.g., routing). Because of the possible variation in the trajectory 360 for the first subtask, the state at the beginning of the second sub-task could be anywhere in the ellipse 370 as indicated by the points. Using the sub-task segmentation technique of the present disclosure, the human demonstration is performed sequentially, in segments, so that the drifting error of a previous sub-task is handled as variation of the initial condition of the next sub-task. Thus, the demonstration data for the second sub-task includes multiple trajectories 380, 382, 384 as shown (a different number of trajectories could be used). With this technique, instead of drifting error accumulating over the course of a trajectory covering the entire task, correction of the drifting is provided in the sub-task demonstration data. This causes the second sub-task trajectories 380/382/384 to all target and fall within an ellipse 390 which is the robot state at the beginning of the third sub-task.

In the same manner as described above, this process is repeated for the third sub-task—where the human demonstration is again performed so that the drifting error of the second sub-task is handled as variation of the initial condition of the third sub-task. The use of sub-task segmentation in the training and inference modes of the diffusion model controller system is discussed further below.

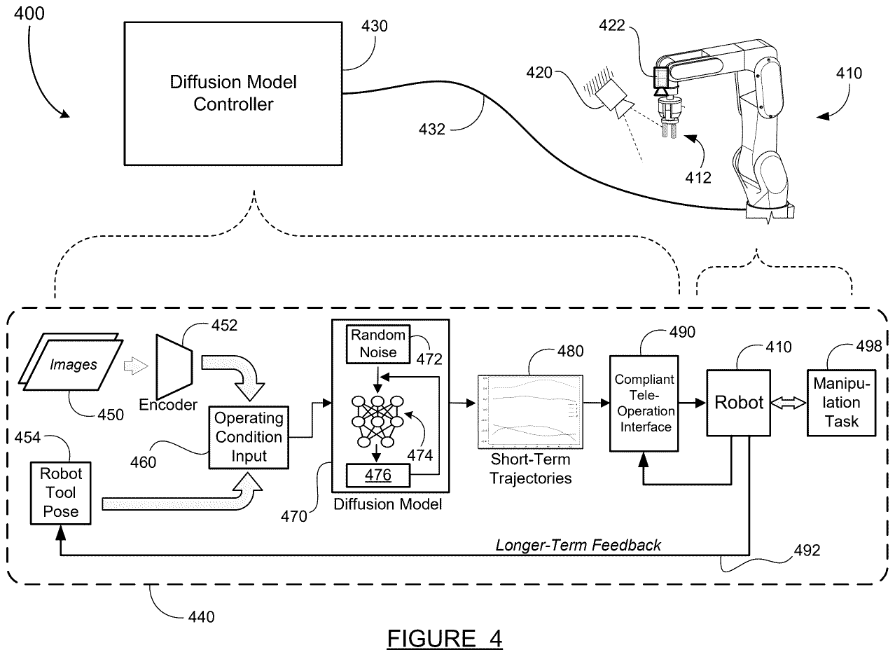

FIG. 4 is a block diagram illustration of a system 400 configured for a robotic operation using a controller with a diffusion model trained to compute robot motions for a difficult manipulation task, according to embodiments of the present disclosure. FIG. 4 depicts the system 400 as it is used in inference mode for performing the manipulation task. Training of the system 400, which is performed for each of the sub-tasks of the overall task, is discussed below.

The top portion of FIG. 4 depicts robot and controller hardware as they exist in the physical world, while the bottom portion depicts the system 400 in block diagram form. In the physical world, a robot 410 operates in a workspace where it is to perform the manipulation task, such as the cable routing task depicted in FIG. 1 and discussed earlier. The robot 410 is fitted with a gripper 412 which is shown generically in FIG. 4. The gripper 412 may be a type which is specifically designed for cable manipulation tasks—such as loosely corralling the cable between fingers to route the cable, and firmly grasping the cable to click it into guide fixtures, for example. Two cameras are shown near the robot 410 in FIG. 4—a fixed global camera 420 which is configured to provide images of the workspace from a fixed point of view, and a robot arm-mounted camera 422 which is mounted on the outer arm of the robot 410, proximal the gripper 412, and provides local images with fine details of the workpiece and fixture environment along with the gripper 412.

The robot 410 communicates with a controller 430 via an interface 432—which may be a physical cable, or may be a wireless interface. The controller 430 is configured with a diffusion model for robot motion computation. The controller 430 provides motion commands to the robot 410, and the robot 410 provides robot state data back to the controller 430 (such as joint positions, and a tool center point position representing the pose of the gripper 412), via the interface 432. Images from the cameras 420 and 422 are also provided to the controller 430, via the interface 432 or otherwise, for controller usage as discussed below.

A block diagram 440, in dashed outline, depicts the features and functions of the system 400. Most of the block diagram 440 shows the logical elements of the diffusion model controller 430, which will be discussed in detail. The block diagram 440 also shows the robot 410 and its execution of the manipulation task, as indicated by the braces above the block diagram 440.

In the block diagram 440 at the top left, images 450 are provided for use in computing robot motions. The images 450 are provided to the controller 430 from both the fixed global camera 420 and the robot arm-mounted camera 422. It has been shown through testing of the system 400 that providing both global workspace scene images and local workpiece detail images yields the best system performance. The images 450 are provided to a vision encoder 452, which is a neural network configured to output feature vectors characterizing the images which are provided. The vision encoder 452 is preferably initialized from a pre-trained image recognition neural network of a type available commercially or via open source. By implementing the vision encoder 452 in pre-trained form, training of the overall diffusion model system (discussed later—and which includes further fine-tuning training of the vision encoder 452) is accelerated.

Robot tool pose data is provided in a block 454. The robot tool pose data defines the position and orientation of the gripper 412—such as in terms of X/Y/Z coordinates and yaw/pitch/roll angular orientations. The data in the block 454 preferably also includes a parameter defining the gripper opening distance. The robot tool pose data from the block 454 and the image feature vectors from the vision encoder 452 together make up operating condition input in a block 460. The operating condition input in the block 460 is provided to a diffusion model 470.

The diffusion model 470 is a neural network module which computes robot trajectories deemed to be most appropriate based on the operating condition input from the block 460. In a block 472, random noise is provided to a neural network 474 as an initial condition, along with the operating condition input from the block 460. The random noise in the block 472 may be a white noise or Gaussian noise of any suitable type. The neural network 474 receives the operating condition input and the random noise, and performs an iterative de-noising computation. In some embodiments, the neural network 474 is a convolutional neural network. Other types of neural networks may also be used as found to be suitable. A first pass through the neural network 474 produces a partially de-noised interim trajectory set 476 based on the operating condition input; that is, what was indecipherable random noise has been partially cleaned up, revealing hints of trajectory traces in the still-noisy data. After the first iteration, the partially de-noised interim trajectory set 476 is provided as feedback to the neural network 474. The neural network 474 uses the partially de-noised interim trajectory set 476, along with the operating condition input from the block 460, to compute a next iteration of the interim trajectory set 476. This iterative process continues for a certain number of iterations (a parameter defined by the user for a particular application), after which a set of short-term trajectories are output to a block 480.

Training of the diffusion model 470, and the subsequent use of the diffusion model 470 in inference mode (as depicted here in the block 470 of FIG. 4), are discussed below in connection with later figures.

The short-term trajectories in the block 480 include trajectories for each degree of freedom (DOF) of the gripper for a short-horizon time frame. For example, if the overall manipulation task (or sub-task) normally takes 15 seconds to be completed, the short-term trajectories in the block 480 might include trajectories for the next 2 seconds. This example is merely illustrative. The short-term trajectories in the block 480 include a trajectory for each gripper DOF—including X/YZ position (typically in a global workspace coordinate frame) and yaw/pitch/roll orientation angles, along with gripper opening width. Other coordinate system conventions may be used, including different types of orientation angles instead of yaw/pitch/roll, as long as the pose and configuration of the gripper is fully defined.

The short-term trajectories in the block 480 are used as reference trajectories provided to a compliant tele-operation interface 490. The compliant tele-operation interface 490 interoperates with the robot 410 (the physical robot from above), providing robot instructions (i.e., joint motion commands) intended to move the robot 410 so that the gripper 412 follows the short-term trajectories from the block 480. The manipulation task being performed by the robot 410 is shown conceptually in a block 498. Interaction between the robot 410, the manipulation task in the block 498 (which involves workpiece contacts and feedback forces) and the compliant tele-operation interface 490 continues for some or all of the timeframe of the short-term trajectories from the block 480.

After some or all of the timeframe of the short-term trajectories from the block 480, the system of the block diagram 440 loops back on a feedback line 492 to compute a next set of short-horizon trajectories based on a new set of operating condition input. This includes providing the gripper states from the robot 410 to the block 454, and also receiving a new set of images 450 and processing them through the vision encoder 452. The new set of operating condition input at the block 460 is again provided to the diffusion model 470 to compute a new set of short-term trajectories 480 for a new short-horizon time frame.

The system 400 is configured for each sub-task in the segmented overall manipulation task. That is, the diffusion model 470 is trained for, and the system 400 is used for, each of the sub-tasks—including grasping, routing and clicking, for example. In other words, when the system 400 is performing the routing sub-task, the diffusion model 470 which was trained for the routing sub-task is used; and likewise for the other sub-tasks. This sub-task segmentation prevents accumulation of drifting error over the course of a long-horizon task, as discussed earlier.

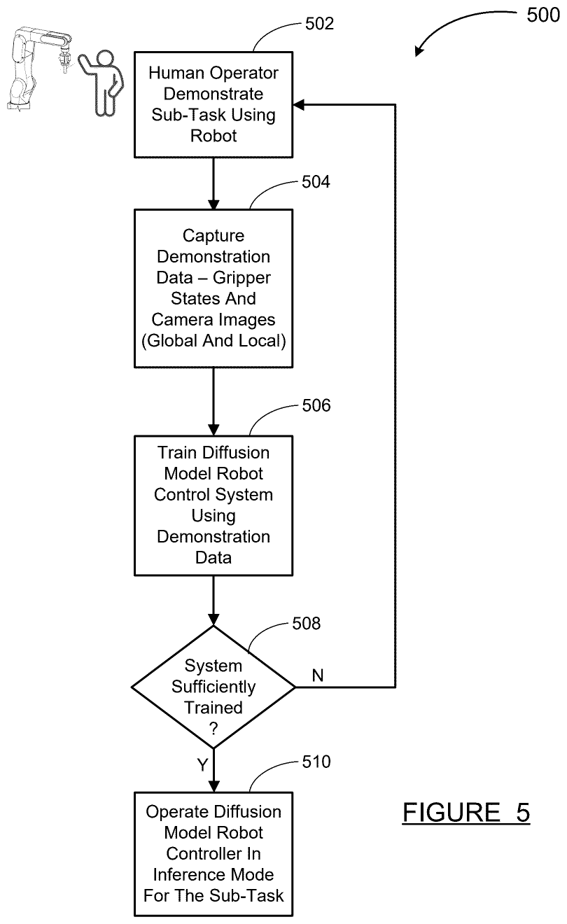

FIG. 5 is a flowchart diagram 500 of a method for training a diffusion model control system to correlate future states with current operating condition input, according to embodiments of the present disclosure. The method of FIG. 5 is performed for each sub-task (e.g., grasping, routing, clicking) of the overall manipulation task. In the training process of FIG. 5, both the de-noising network (the neural network 474) and the vision encoder 452 of FIG. 4 are trained. The flowchart diagram 500 of FIG. 5 describes the high-level steps of the diffusion model training process. Details are provided in a later figure and discussed below.

At box 502, a human operator demonstrates the sub-task using a collaborative robot (a robot designed for inter-operation with a human—where the human operator physically moves the robot arm so that the gripper accomplishes the desired task, for example) or using a robot with tele-operation capability or an input device such as a teach pendant. At box 504, data from the human demonstration is captured and stored for system training. The data which is collected at the box 504 includes the robot gripper states (position, orientation and gripper opening distance) along with the images from both the fixed global camera 420 and the robot arm-mounted camera 422.

At box 506, the demonstration data collected at the box 504 is used for training the elements of the diffusion model control system (the de-noising network and the vision encoder) for the sub-task which was demonstrated. Using the human demonstration data, the vision encoder learns to provide feature vectors from the images which are most effective as input to the de-noising network, and the de-noising network learns to progressively de-noise a set of trajectories based on the operating condition inputs to correlate future states to current state inputs.

At decision diamond 508, it is determined whether the system is sufficiently trained to operate autonomously in inference mode. This determination is made by evaluating results of test operations in inference mode. If more training is needed, the process loops back to the box 502 for another cycle of human demonstration of the sub-task. Because the human operator will not demonstrate the sub-task with exactly the same motions each time, the repeated cycles of human demonstration builds robustness to variation in the trained system. In most applications, several complete human demonstrations of the task are needed for system training. When test results indicate that the system is sufficiently trained, at box 510 the diffusion model control system is deployed to operate in inference mode for the sub-task. That is, the system is used as depicted in FIG. 4 to compute reference trajectories used by the robot to perform the sub-task (e.g., cable routing). The training process depicted in FIG. 5 is performed for each of the sub-tasks of the overall manipulation task. The human demonstration may be performed in a continuous fashion for the complete manipulation task; the captured demonstration data is then divided into sub-tasks for system training.

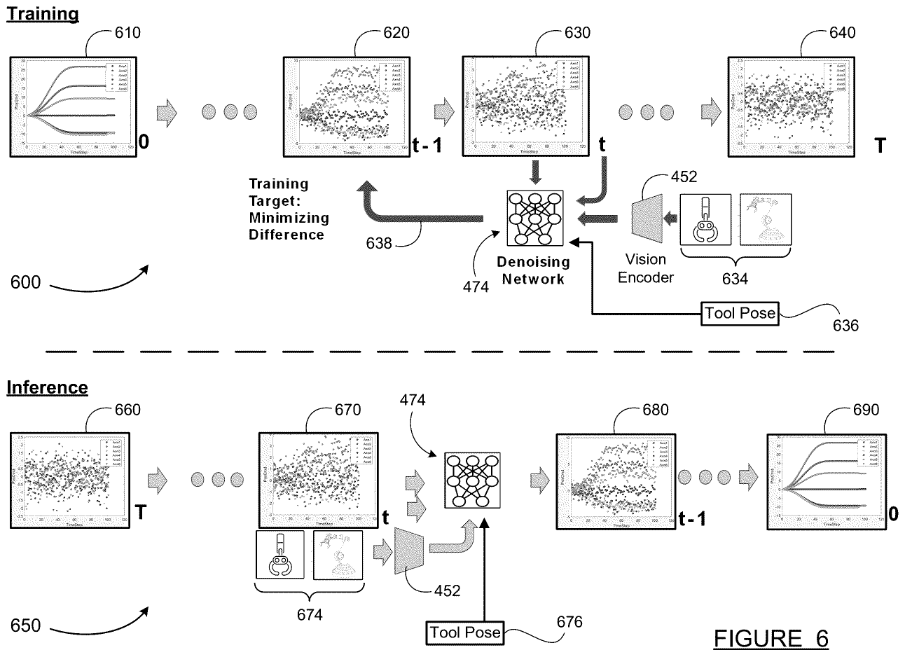

FIG. 6 is a block diagram illustration of a technique for training a diffusion model control system to correlate future states with current operating condition input using demonstration data, and a corresponding technique for using the trained diffusion model system for robot control based on gripper states and image data input, according to embodiments of the present disclosure.

In the upper part of FIG. 6, a block flow diagram 600 depicts the steps included in training the diffusion model control system of FIG. 4. In this training process, both the de-noising neural network 474 and the vision encoder 452 (depicted in FIG. 4) are trained. Both the training of the diffusion model and its use in inference mode are performed in a multi-step iterative process. The training process is depicted beginning at a step 0, performing some number of diffusion iterations to arrive at a step t-1 followed by a step t (for which the details of the step are shown and described), performing more iterations and finally arriving at a step T. The process in inference mode (bottom part of FIG. 6, discussed below) progresses through these same diffusion iteration steps in reverse order. The number of iteration steps may be chosen to provide best results for a particular application.

The logic behind the diffusion model is as follows: a set of operating condition input (encoded images from both cameras, plus robot gripper states) are used by the diffusion model to generate a short-horizon trajectory for all gripper DOF. This inference capability is achieved through training the de-noising network in the diffusion model. The vision encoder is also trained simultaneously.

In block 610 of the training process, a short-horizon trajectory set (a trajectory for each gripper DOF) from the demonstration data is provided. These are actual recorded trajectories from the human demonstration of the manipulation task, and are designated as diffusion iteration step 0. In each diffusion iteration step in training, a small amount of noise is added to the short-horizon trajectories, and the added noise is recorded at each step. This is depicted in the diagram 600 as follows; after some number of diffusion iterations, a block 620 contains a set of noise-added trajectories for iteration step t-1, following which a block 630 contains a set of noise-added trajectories for iteration step t, and finally, after some number of additional diffusion iterations, a block 640 contains a very noisy set of trajectories for a final diffusion iteration step T.

The training process which is followed at each diffusion iteration step is depicted for the iteration step t in comparison to the preceding iteration step t-1. The noise-added trajectories for iteration step t, in the block 630, are provided to the de-noising neural network 474 which is being trained. A pair of images 634 (one from each of the cameras 420, 422) is provided to the vision encoder 452 (which was pre-trained, and is being fine-tuning trained). The vision encoder 452 provides the encoded images—that is, the feature vectors characterizing the images—to the de-noising network 474. Tool pose data (all six gripper DOF plus gripper opening width) in a block 636 is also provided to the de-noising network 474. Based on all of these inputs, the de-noising network 474 computes what it believes the trajectories looked like before the most recent noise-adding step—that is, in this case, the de-noising network 474 computes its estimate of the trajectories for the diffusion iteration step t-1 in the block 620. The objective of the diffusion model training is to minimize the difference between of the predicted de-noised output of the neural network 474 (on feedback line 638) and the trajectories in the block 620.

For a given short-horizon trajectory in the block 610, the operating condition input (the pair of images 634 and the tool pose data in the block 636) are the same for all diffusion iterations steps. Through this training, the de-noising neural network 474 learns inter-layer node connectivity and network parameters which most effectively de-noise the trajectory set based on a given set of operating condition input. The vision encoder 452 also learns how to most effectively encode the camera images for most effective system performance.

As discussed earlier, sub-task segmentation is used in the presently disclosed method, so the diffusion model control system is trained and used specifically for each sub-task (e.g., grasping, routing and clicking—for a cable routing application). Also, as shown on the flowchart diagram of FIG. 5, the human demonstration of the task is performed a number of times, so that the training of the diffusion model builds robustness to variations in trajectories and images. Thus, the training process depicted in the diagram 600 is performed for each of these demonstration data sets. In addition, the short-horizon time window which is contained in the blocks 610-640 only includes part of the demonstration data set for the sub-task; therefore, the training process is performed for several different short-horizon time windows for each sub-task demonstration data set.

In the lower part of FIG. 6, a block flow diagram 650 depicts the diffusion iteration steps included in using the diffusion model control system in inference mode as depicted in FIG. 4. As mentioned above, the trained diffusion model system is used to compute a set of short-horizon trajectories (for all gripper DOF) for robot control, based on gripper states and image data input. This process is depicted as beginning with a very noisy data set in a block 660 at a first diffusion iteration step T. The very noisy data set in the block 660 is a randomly sampled noise sequence which includes the same gripper DOF and uses the same short-horizon time window as the other trajectory blocks of FIG. 6. After some number of diffusion iterations, a block 670 contains a set of partially-denoised trajectories for iteration step t, following which a block 680 contains a set of further-denoised trajectories for iteration step t-1, and finally, after some number of additional diffusion iterations, a block 690 contains the set of short-horizon trajectories (for all gripper DOF) to be used for robot control, at a last diffusion iteration step 0.

The de-noising process which is followed at each diffusion iteration step in inference mode is depicted for the iteration step t proceeding to the iteration step t-1. The partially-denoised trajectories for iteration step t, in the block 670, are provided to the de-noising neural network 474 (which has been trained as discussed above). A pair of images 674 (one from each of the cameras 420, 422) is provided to the vision encoder 452 (also trained as discussed above). The vision encoder 452 provides the encoded images (the feature vectors characterizing the images) to the de-noising network 474. Tool pose data (all six gripper DOF plus gripper opening width) in a block 676 is also provided to the de-noising network 474. Based on all of these inputs, the de-noising network 474 computes the next set of further-denoised trajectories—that is, in this case, the de-noising network 474 computes the trajectories for the diffusion iteration step t-1 in the block 680. This process continues for some additional number of diffusion iterations until reaching iteration step 0, where the final set of trajectories for all gripper DOF, in the block 690, are used by the compliant tele-operation interface 490 for robot control during the short-horizon time window—as was shown in FIG. 4.

For a particular short-horizon trajectory computation as depicted in the blocks 660-690, the operating condition input (the pair of images 674 and the tool pose data in the block 676) are the same for all diffusion iteration steps. In the embodiment shown in FIG. 6, the operating condition input includes a pair of images and robot/gripper states at a current robot time step. In other embodiments, the operating condition input may include a pair of images and robot/gripper states for a sequence of robot time steps—e.g., the current robot time step, and one or more preceding time steps.

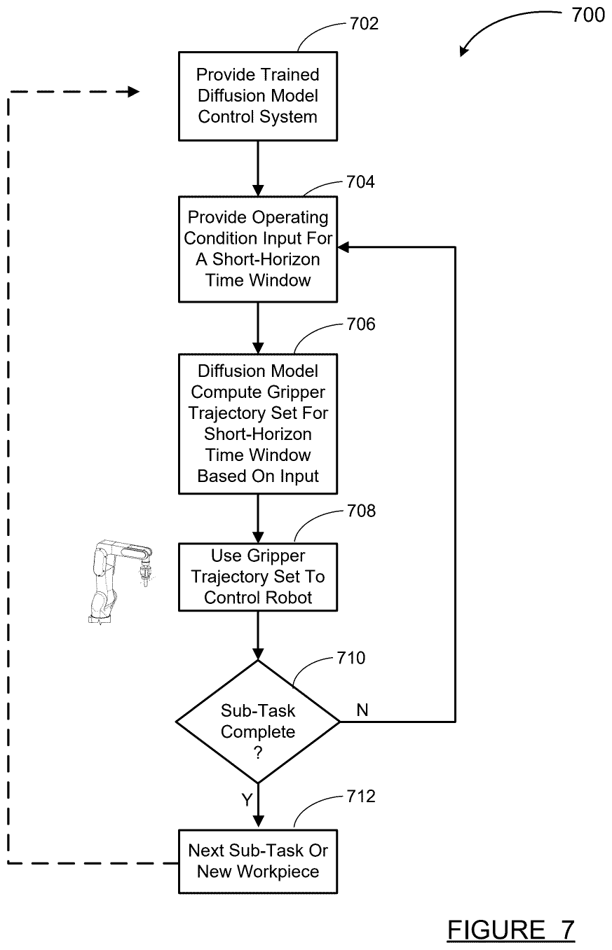

FIG. 7 is a flowchart diagram 700 of a method for operating a diffusion model control system in inference mode to control robot future states based on current operating condition input, according to embodiments of the present disclosure. The flowchart diagram 700 of FIG. 7 is what is performed in the box 510 of FIG. 5.

A diffusion model control system is provided at box 702. This is the diffusion model control system depicted on the left-hand side of FIG. 4. The diffusion model control system provided at the box 702 has been trained for a particular sub-task using human demonstration data as described on the flowchart diagram of FIG. 5, and as depicted in the upper part of FIG. 6.

At box 704, operating condition input is provided to the diffusion model control system for an upcoming short-horizon time window. The operating condition input includes images from the fixed global camera 420 and the local arm-mounted camera 422 of FIG. 4, along with a set of gripper pose states (all gripper DOF). The camera images are encoded using the vision encoder 452 before being used by the diffusion model in the control system.

At box 706, the diffusion model in the control system computes a gripper trajectory set for the short-horizon time window. This is done using the step-wise iterative de-noising computation described in detail earlier. That is, beginning with a random noise sample, the de-noising neural network 474 computes progressively de-noised iterations of the gripper trajectory set based on the operating condition input. After a prescribed number of diffusion iterations, the gripper trajectory set is provided to the compliant tele-operation interface 490.

At box 708, the gripper trajectory set for the short-horizon time window is used to control the robot for at least a portion of the short-horizon time window. This involves the interface providing instructions to the robot to follow the gripper trajectory set and the robot providing state and force feedback to the interface at a first control cycle frequency (e.g., several times per second).

After some or all of the short-horizon time window, it is determined at decision diamond 710 whether the sub-task being performed is complete. If not, the process loops back to the box 704 to provide a new set of operating condition input for a next short-horizon time window. This looping back was shown as the feedback line 492 of FIG. 4. This looping back occurs at a longer-term cycle frequency (e.g., every one to two seconds, based on the length of the short-horizon time window).

When the sub-task is complete at the decision diamond 710, a next sub-task or a new workpiece is started at box 712. This involves starting the process over at the box 702 with the trained diffusion model control system for the appropriate upcoming sub-task.

The methods and system of FIGS. 4-7, configured with sub-task segmentation as shown in FIG. 3, provide many advantages in robot manipulation skill learning. The de-noising neural network in the diffusion model—using robot gripper states and camera images as input—has been demonstrated to effectively compute gripper trajectories which successfully complete the manipulation task. Training of the diffusion model by human demonstration is intuitive and straightforward to accomplish, and builds robustness to task variation into the trained system. Using both global and local camera image input provides a comprehensive scene understanding, helping the controller learn to make decisions using both the overall environment situation and detailed perception of target objects. In addition, task segmentation overcomes problems with drift and accumulated error, further improving system performance.

Throughout the preceding discussion, various computers and controllers are described and implied. It is to be understood that the software applications and modules of these computers and controllers are executed on one or more computing devices having a processor and a memory module. In particular, this includes a processor in the diffusion model controller 430 which controls the robot 410 performing the manipulation task as shown in FIG. 4. The controller 430 performs the diffusion model control as depicted in FIGS. 4, 6 and 7, and the controller 430 or a separate computer performs the diffusion model training as depicted in FIGS. 5 and 6.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A method for robotic manipulation skill learning, said method comprising:
providing a robot and a controller with a diffusion model, the robot being configured with a gripper to perform an operation on a workpiece, and the diffusion model being trained for a sub-task of the operation;
providing operating condition input to the diffusion model, including robot gripper states and camera images of the operation, the camera images being encoded by a vision encoder;
computing a trajectory set for all gripper degrees of freedom (DOF) for a short-horizon time window, by the diffusion model in the controller, including using a de-noising neural network to iteratively compute a plurality of progressively de-noised interim trajectories based on the operating condition input;
controlling the robot to move the gripper according to the trajectory set, by a compliant control interface running on the controller; and
at a time less than or equal to the short-horizon time window, providing new operating condition input to the diffusion model and computing a trajectory set for a next short-horizon time window, until the sub-task of the operation is complete.

2. The method according to claim 1 wherein the camera images include images from a fixed workspace camera and a robot arm-mounted camera.

3. The method according to claim 1 wherein the robot gripper states include three position and three orientation DOF states of the gripper and a gripper opening width state.

4. The method according to claim 1 wherein computing a trajectory set includes starting with a random noise sample and using the de-noising neural network to iteratively compute the plurality of progressively de-noised interim trajectories using the operating condition input at each iteration until a defined number of iterations is completed.

5. The method according to claim 1 wherein the de-noising neural network included in the diffusion model is trained using a training dataset including data from multiple human demonstrations of the operation using the robot.

6. The method according to claim 5 wherein the training dataset is segmented into a plurality of sub-tasks comprising the operation.

7. The method according to claim 6 wherein a separate instance of the diffusion model is created for each of the sub-tasks, and the instance of the diffusion model used to compute the trajectory set in the controller is trained using only a portion the training dataset for a corresponding sub-task.

8. The method according to claim 5 wherein the vision encoder is pre-trained to output feature vectors characterizing the camera images, and the vision encoder is further trained concurrently with the de-noising neural network using the training dataset.

9. The method according to claim 5 wherein the training of the de-noising neural network includes iteratively adding noise to a short-horizon trajectory set from the training dataset and training the de-noising neural network to remove the noise added at each iteration, using training operating condition inputs corresponding to the short-horizon trajectory set from the training dataset.

10. The method according to claim 1 wherein the compliant control interface controls the robot using a control cycle having a time period shorter than that short-horizon time window, and on each control cycle the compliant control interface computes a target robot motion based on the trajectory set and force and state feedback from the robot.

11. The method according to claim 1 wherein the operation is a manipulation operation performed on a flexible workpiece.

12. A method for robotic manipulation skill learning, said method comprising:
providing a robot and a controller with a diffusion model, the robot being configured with a gripper to perform an operation on a workpiece;
training a de-noising neural network in the diffusion model using a training dataset including data from multiple human demonstrations of the operation performed using the robot, where the training dataset is segmented into a plurality of sub-tasks comprising the operation, and the de-noising neural network is trained for each particular sub-task using only training data from a corresponding sub-task;
providing operating condition input to the diffusion model, including robot gripper states and camera images of the operation, where the camera images include images from a fixed workspace camera and a robot arm-mounted camera, and the camera images are encoded by a vision encoder;
computing a trajectory set for all gripper degrees of freedom (DOF) for a short-horizon time window, by the diffusion model in the controller, including using the de-noising neural network to iteratively compute a plurality of progressively de-noised interim trajectories based on the operating condition input;
controlling the robot to move the gripper according to the trajectory set, by a compliant control interface running on the controller, including controlling the robot using a control cycle having a time period shorter than that short-horizon time window, where on each control cycle the compliant control interface computes a target robot motion based on the trajectory set and force and state feedback from the robot; and
at a time less than or equal to the short-horizon time window, providing new operating condition input to the diffusion model and computing a trajectory set for a next short-horizon time window, until the sub-task of the operation is complete, then moving on to a next sub-task until the operation is complete.

13. The method according to claim 12 wherein the vision encoder is pre-trained to output feature vectors characterizing the camera images, and the vision encoder is further trained concurrently with the de-noising neural network using the training dataset.

14. The method according to claim 12 wherein the training of the de-noising neural network includes iteratively adding noise to a short-horizon trajectory set from the training dataset and training the de-noising neural network to remove the noise added at each iteration, using training operating condition inputs corresponding to the short-horizon trajectory set from the training dataset.

15. A robotic manipulation skill learning system, said system comprising:
a robot configured with a gripper to perform an operation on a workpiece;
a fixed workspace camera and a robot arm-mounted camera; and
a controller in communication with the robot and the cameras, where the controller includes a diffusion model trained for a sub-task of the operation,
where the controller is configured to perform steps including;
providing operating condition input to the diffusion model, including robot gripper states and camera images of the operation, the camera images being encoded by a vision encoder;
computing a trajectory set for all gripper degrees of freedom (DOF) for a short-horizon time window, by the diffusion model in the controller, including using a de-noising neural network to iteratively compute a plurality of progressively de-noised interim trajectories based on the operating condition input;
controlling the robot to move the gripper according to the trajectory set, by a compliant control interface running on the controller; and
at a time less than or equal to the short-horizon time window, providing new operating condition input to the diffusion model and computing a trajectory set for a next short-horizon time window, until the sub-task of the operation is complete.

16. The system according to claim 15 wherein the robot gripper states include three position and three orientation DOF states of the gripper and a gripper opening width state.

17. The system according to claim 15 wherein computing a trajectory set includes starting with a random noise sample and using the de-noising neural network to iteratively compute the plurality of progressively de-noised interim trajectories using the operating condition input at each iteration until a defined number of iterations is completed.

18. The system according to claim 15 wherein the de-noising neural network included in the diffusion model is trained using a training dataset including data from multiple human demonstrations of the operation using the robot.

19. The system according to claim 18 wherein the training dataset is segmented into a plurality of sub-tasks comprising the operation.

20. The system according to claim 19 wherein a separate instance of the diffusion model is created for each of the sub-tasks, and the instance of the diffusion model used to compute the trajectory set in the controller is trained using only a portion the training dataset for a corresponding sub-task.

21. The system according to claim 18 wherein the vision encoder is pre-trained to output feature vectors characterizing the camera images, and the vision encoder is further trained concurrently with the de-noising neural network using the training dataset.

22. The system according to claim 18 wherein the training of the de-noising neural network includes iteratively adding noise to a short-horizon trajectory set from the training dataset and training the de-noising neural network to remove the noise added at each iteration, using training operating condition inputs corresponding to the short-horizon trajectory set from the training dataset.

23. The system according to claim 15 wherein the compliant control interface controls the robot using a control cycle having a time period shorter than that short-horizon time window, and on each control cycle the compliant control interface computes a target robot motion based on the trajectory set and force and state feedback from the robot.

24. The system according to claim 15 wherein the operation is a manipulation operation performed on a flexible workpiece.
